(19) United States
(12) Patent Application Publication
(10) Pub. No.: US 2005/0166649 A1
(43) Pub. Date: Aug. 4, 2005

(54) Combination Deadbolt

(75) Inventor: Glenn P. Meekma, Menomonee Falls, WI (US)

Correspondence Address: CALFEE HALTER & GRISWOLD, LLP, 800 SUPERIOR AVENUE, SUITE 1400, CLEVELAND, OH, 44114, US

(73) Assignee: MASTER LOCK COMPANY, Oak Creek, WI (US)

(21) Appl. No.: 10/906,120

(22) Filed: Feb. 3, 2005

Related U.S. Application Data
(60) Provisional application No. 60/521,002, filed on Feb. 3, 2004.

(51) Int. Cl. E05B 65/06; E05B 37/00

(52) U.S. Cl. 70/134; 70/284; 70/285

(57) ABSTRACT

A deadbolt which can be used with current door hardware to lock and unlock a door. The deadbolt can be operated by two independent locking mechanisms, such as a key cylinder or a three digit, right-left-right, combination dial. The two locking mechanisms are independent to maintain the integrity of the deadbolt lock.

### FIELD OF THE INVENTION

This application is directed to a deadbolt lock mechanism, and more particularly to a combination deadbolt which can be used with current door hardware to lock and unlock a door.

### BACKGROUND

Traditional door locks are operated by lock and key mechanisms that employ a lock cylinder and deadbolt. When a properly bitted key is placed into the keyway of the lock cylinder, the cylinder pins are displaced and the cylinder is allowed to rotate. Rotation of the cylinder allows for interaction with the deadbolt to move the deadbolt to and from the locked, extended position. In this manner, only a person with the proper key can obtain authorized entry through the door.

However, there are times that an authorized person can not gain access through the door because they do not have the key. For example, the key may be lost or with another authorized individual. This is frequently the case when there are multiple authorized persons, and especially when children are among the authorized persons.

As such, it is desirable to provide a door lock that allows authorized persons to gain access through the doorway when they do not have the proper key. However, in doing so, the integrity of the door lock cannot be compromised such as to allow easy access by unauthorized persons.

### SUMMARY OF THE INVENTION

The present invention relates to a lock assembly including more than one mechanism for actuating a deadbolt. The mechanisms used to actuate the deadbolt operate independently of one another to ensure the integrity of the lock. In one embodiment, the lock includes independently operating key cylinder and combination dial mechanisms.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention.

FIG. 1 is an exploded view of a combination deadbolt of the present invention;

FIG. 2 is a front view of the combination deadbolt shown in FIG. 1;

FIG. 3 is a side view of the combination deadbolt shown in FIG. 1;

FIG. 4 is a front perspective view of the combination deadbolt shown in FIG. 1;

FIG. 5 is a rear perspective view of the combination deadbolt shown in FIG. 1;

FIG. 6 is a back view of the combination deadbolt shown in FIG. 1; and

FIG. 7 is a top view of the combination deadbolt shown in FIG. 1.

### DESCRIPTION OF THE INVENTION

The present invention is directed to a deadbolt locking mechanism for use on a door, and more specifically a deadbolt locking mechanism that has at least two separate and independent mechanisms for manipulating the deadbolt to and from the extended locked position. The embodiments described herein generally discuss a mechanism that employs both a key cylinder and a combination dial set as the means for manipulating the deadbolt; however it should be appreciated that this is merely an embodiment of the present invention and that other embodiments are contemplated and are considered apart of this application to the extent they fall within the scope of the claims.

The lock shown in the illustrative embodiment includes a lock cylinder and a combination dial, each used to operate the deadbolt to move it to and from the locked extended position. These two mechanisms operate independently of each other. Thus, each mechanism does not use or integrate any of the components of the other mechanism to operate the deadbolt. As such, the integrity and security of the lock is increased. This is because interaction between the components of the two mechanisms can provide assistance to unauthorized persons who may attempt to gain access through the doorway. For example, an unauthorized person that has access to the cylinder through a lock “pick” could also gain access to the combination mechanism in other prior art devices.

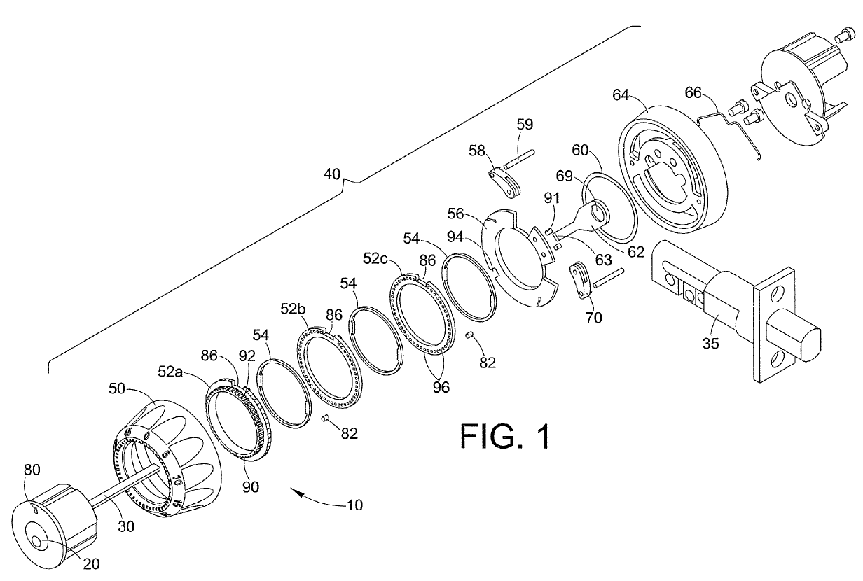

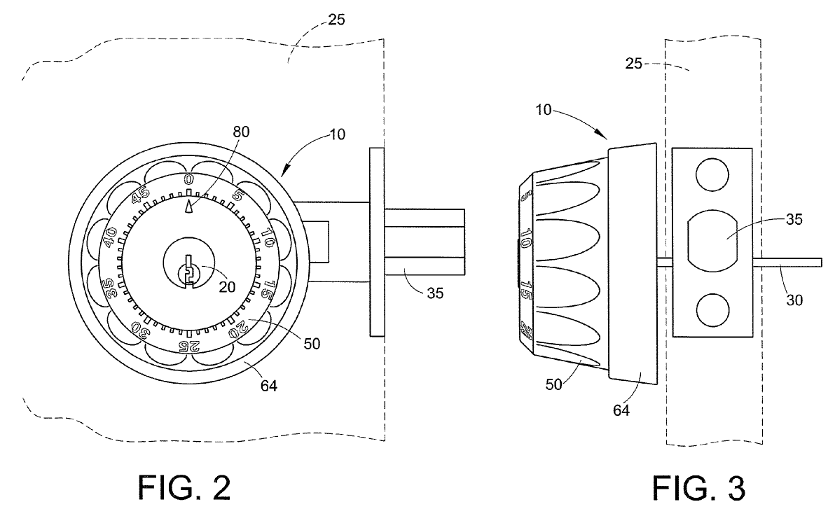

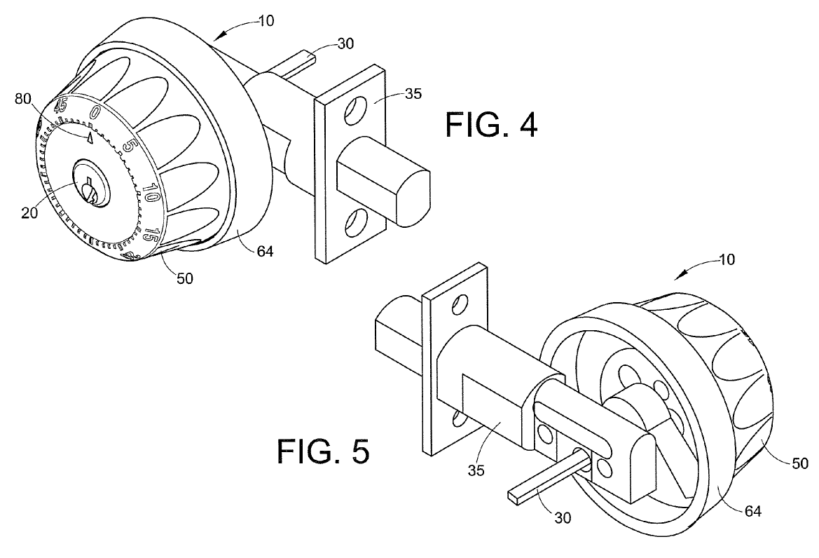

Referring now to FIG. 1, the lock 10 consists of a key driven cylinder assembly 20 which operates by insertion of a correct key to align the tumbler pins (not shown) and allow the cylinder 20 to rotate. The cylinder 20 includes a tailpiece 30 which drives the deadbolt 35 to a retracted position or an extended position. In this manner, the rotation of the cylinder 20 actuates the deadbolt 35 and moves it to and from the locked position.

The lock 10 also includes a combination lock assembly 40, which can drive the tailpiece 30, and thus the deadbolt 35. The combination lock assembly 40 includes a dial 50, three combination disks 52, three disk spacers 54, a drive disk 56, a drive pawl 58, a pin 59, a wave washer 60, a tail drive 62, a cylinder plate 64, and one or more springs 66. It should be appreciated that the number of combination disks 52 directly correlates to the number of digits or numbers that are apart of the correct combination. As such, the number of combination disks 52 can be increased if a larger combination is desired. The combination lock assembly 40 may also include a second drive pawl assembly 70.

The combination lock assembly 40 does not use or integrate any portion or component of the key driven cylinder 20 to operate the deadbolt 35. The combination lock assembly 40 and key driven cylinder 20 are independent of one another. For example, the use of the combination dial does not require movement of the lock cylinder pins in order to actuate the deadbolt.

The combination lock assembly 40 is assembled over the cylinder 20 to construct a lock 10 which is mounted to a door 25, such as, for example, the outside of an entry door. The combination lock assembly 40 interfaces with the deadbolt 35 to provide a locked and unlocked position. The cylinder 20 and the combination lock assembly 40 are independent of each other in that the key will open the lock 10 without the combination being dialed and the combination will open the lock 10 without the key being present. This maintains the integrity of the lock 10.

The face of the cylinder assembly 20 includes an indicator mark 80 which corresponds to numbers on the face of the dial 50 to indicate the numbers of the combination as the dial 50 is turned. Inside the dial 50 are a series of combination disks 52 and spacers 54 which, depending on the placement of the first combination disk 52a and the placement of the disk pins 82 in the second and third combination disks 52b and 52c, combine to determine the numbers in the combination. By placing the combination disks 52 within the dial 50, the dial acts as a protective housing for the combination disks and prevents access to the combination disks should an unauthorized user attempt to “pick” the lock. Indeed, the dial 50 acts as a protective shield or housing for both the combination lock assembly 40 and key driven cylinder 20. The dial 50 is comprised of metal and is approximately 1/8 inch thick, and preferably between 1/16 inch and 3/8 inch thick. However, one skilled in the art should appreciate that the dial 50 could be any suitable thickness such as to provide protection to the overall assembly. Thus, the thickness of the dial 50 provides added protection and security for the entire lock, while also providing an sleek and elegant appearance. The combination disks 52, which contain a notch 86 and a fixed drive lug operate to provide a left-right-left. Alternatively, the combinations disks can be configured for a right-left-right, combination, however such combination methods are not considered conventional.

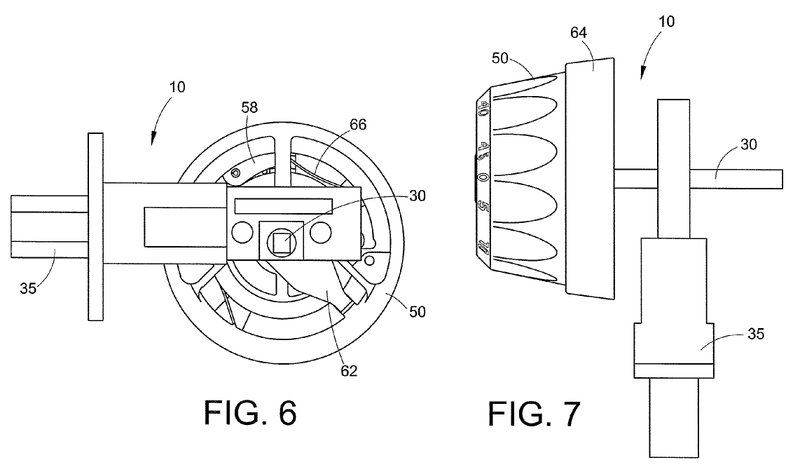

As can be seen in FIGS. 6 and 7, the dial 50 completely surrounds combination disks 52 and the key driven cylinder 20. The cylinder 20 is then surrounded by the dial 50 and the combination disks 52, such that the cylinder 20 is in the center of the lock 10. This provides an elegant and compact design that is encased by protective dial 50.

The first combination disk 52a includes a raised shoulder 90 that contains a spline feature, or some similar interlocking feature, which interfaces with the dial 50 so that the dial directly drives the first combination disk 52a when the dial is turned. Dial 50 includes a corresponding interlocking feature, such as, for example, a series of teeth, (not shown) that interlock with the raised shoulder 90. This allows the first combination disk 52a to be placed in multiple positions with the dial 50 to set the last number of the combination. For example, one placement of the first combination disk 52a will provide one corresponding last number of the combination, while rotating the first combination disk to a second position within the dial 50 provides a different last number of the combination.

On the bottom of the first combination disk 52a there is also a fixed pin, protrusion or other device 92 that extends back towards the second combination disk 52b to interface with a pin 82 extending forward from the second combination disk 52b. When the first combination disk 52a is turned, the fixed pin contacts the pin 82 of the second combination disk 52b, thereby driving the second combination disk 52b. There is a similar interface between the second and third combination disks 52b and 52c. The second and third combination disks 52b and 52c include a plurality of holes 96 located radially about the face of the disks. The plurality of holes 96 allows the disk pins 82 to be placed in different positions on the combination disks, thereby providing for different combinations depending on the location of the disk pins 82. Thus, by disassembling the lock 10 and changing the pin 82 locations on the second and third combination disks 52b and 52c and the first combination disk 52a within the dial 50, new combinations can be set.

Between each of the combination disks 52 is a disk spacer 54 that is keyed or secured to the cylinder housing. The disk spacers 54 do not turn when the combination disks 52 are turned, thereby allowing the combination disks located further away from the dial 50 to remain stationary upon change in the direction of the rotation of the dial 50.

Each of the three combination disks 52 include a notch 86. When the proper set of combination numbers is dialed by the user, the notch 86 in all three combination disks 52 are aligned with each other and in the proper position within the lock assembly to allow pin 59 from the drive pawl 58 which is located over the outer edge of the combination disks 52, to drop into the notches 86. This allows the dial 50, via the pin 59 within the notches 86 in the combination disks 52, to drive the pawl 59 in the direction that the dial 50 is being turned. The pin 59 also extends back from the pawl 58 and is contacted by the spring or other biasing means 66. The spring 66 biases the pin 59 radially towards the combination disks 52 and into the combination disk notches 86 when the bolt 35 of the lock 10 is in the extended position. The spring 66 may also bias the pin 59 out of the notches 86 when the bolt 35 of the lock 10 is in the retracted position. Alternatively a second spring or biasing means can be used return the pin 59 to its position out of the notches 86. When the bolt 35 of the lock 10 is retracted via the combination dial 50, the pawl pin 59 is sprung out of the notches 86, and the bolt 35 is re-extended by either an inside knob or the key from the outside. This action will successfully upset the combination, i.e. will misalign the notches 86 of the combination disks 52 with the pin 82. In order to retract the bolt 35 via the combination, the correct combination will need to be redialed.

The pawl 58 is attached to the drive disk 56 by pin 91, allowing the pawl pin 59 to rotate in and out of the notches 86 in the combination disks 52. The drive disk 56 has a notch 94 radially opposite the pawl 58 that interface with a tab 63 that extends forward from the tail drive 62. With tab 63 secured within notch 94, rotation of the drive disk 56 causes rotation of the tail drive 62, which in turn translates the rotation to the tailpiece 30 which interacts with tail drive through mating hole 69. When the lock 10 is assembled, the drive disk 56, combination disks 52 and spacer disks 54 are biased axially forward in the dial 50 and tight up against each other by a wave washer 60 that is placed between the cylinder plate 64 and the drive disk 56.

The tail drive 62 includes a feature that interfaces with the tailpiece 30 extending from the back of the cylinder assembly 20. In one embodiment, the tail drive 62 interfaces with the tailpiece 30 through a mating hole 69. This feature allows the tail drive 62 to drive the tailpiece 30 radially when the proper combination is entered into the lock 10. By driving the tailpiece 30 radially, the deadbolt 35 is driven to a retracted position. With the way that the tail drive 62 fits into the cylinder plate 64, if the dial assembly 50 is properly assembled and interfaced with the deadbolt 35, once the proper combination is entered into the lock 10, the dial 50 will only be allowed to turn in the direction that will retract the bolt 35. On a left-hinged door, the combination would be dialed right (clockwise), left, right and then the dial 50 would be turned left to retract the deadbolt 35. On a right-hinged door, the combination would be dialed right, left, right and then the dial 50 would be turned right again to retract the bolt 35.

A second drive pawl and pin assembly 70 can be used to provide rotation in the opposite direction. This would allow the combination dial 50 to be used to move the deadbolt 35 to the locked position in addition to the unlocked position.

An optional feature that can be added to the lock 10 is an LED device that is actuated by turning the combination dial 50. The LED can also be activated in other ways, such as, for example, depressing the combination dial 50 or by a motion sensor. The LED device would contain a power supply, such as a small battery, a circuit board, and an LED and light pipe to carry light from the LED to the area of the dial and cylinder to be illuminated. In one embodiment, the act of turning the dial 50 would activate the circuit board, which will in turn, active the LED. The LED would remain illuminated for a set period of time to allow the user to have sufficient time to dial the combination. The light pipe carries the light to the appropriate area on the lock assembly, such as to illuminate the indicator mark 80 on the face of the cylinder assembly and project the light onto the area adjacent to the indicator mark on the face of the dial where the numbers are located to indicate the number currently being dialed. By incorporating the LED device into the lock assembly 10, the lock assembly can also be applied to use in area wherein insufficient ambient lighting would render the combination entry difficult.

In some embodiments, the lock 10 includes an additional security component or “lockout component” that renders the lock inoperable through either mechanism which the additional security component is activated. For example, the lock 10 may have a thumbturn (not shown) located on the opposite side of the lock 10 as the dial 50 and cylinder 20 for actuation of the deadbolt 35. In some embodiments, the tumbturn can be pulled outward from the lock 10 thereby preventing rotation of the tailpiece 30 and hence the operation of the deadbolt 35. By pushing the thumbturn back in towards the lock 10 the tailpiece 30 is permitted to rotate to make the deadbolt operable.

The invention has been described with reference to the preferred embodiment. Clearly, modifications and alterations will occur to others upon a reading and understanding of this specification. It is intended to include all such modifications and alterations insofar as they come within the scope of the appended claims or the equivalents thereof.

1. A deadbolt locking assembly comprising:
a first locking mechanism for actuating a deadbolt;
a second locking mechanism for actuating said deadbolt;
wherein said first and second locking mechanisms for actuating said deadbolt operate independently of one another.

2. The deadbolt locking assembly of claim 1, wherein said first locking mechanism is a key-operated lock cylinder.

3. The deadbolt locking assembly of claim 1, wherein said second locking mechanism is a combination dial assembly.

4. The deadbolt locking assembly of claim 1, wherein said first locking mechanism is a key-operated lock cylinder and said second locking mechanism is a combination dial assembly.

5. The deadbolt locking assembly of claim 4, wherein said combination dial assembly comprises a combination dial and at least three combination disks.

6. The deadbolt locking assembly of claim 5, wherein said at least three combination disks are disposed within said combination dial.

7. The deadbolt locking assembly of claim 1, wherein said deadbolt locking assembly can operate on a right-handed door or a left-handed door.

8. The deadbolt locking assembly of claim 1 further comprising a light source that illuminates a portion of said deadbolt locking assembly.

9. A deadbolt locking assembly comprising:
a key-operated lock cylinder for actuating a deadbolt;
a combination dial assembly for actuating said deadbolt;
wherein said key-operated lock cylinder and said combination dial assembly operate independently of one another.

10. The deadbolt locking assembly of claim 9, wherein said deadbolt locking assembly can operate on a right-handed door or a left-handed door.

11. The deadbolt locking assembly for claim 9, wherein said combination dial assembly comprises a combination dial, a drive disk, and three or more combination disks.

12. The deadbolt locking assembly of claim 11, wherein said three or more combination disks are disposed within said combination dial.

13. The deadbolt locking assembly of claim 11, wherein said combination dial assembly further comprises a set of pins interconnecting said dial, said drive disk and said three or more combination dials.

14. The deadbolt locking assembly of claim 13, wherein said set of pins interconnecting said dial, said drive disk and said three or more combination dials can be moved within said combination dial assembly to provide multiple lock combinations.

15. The deadbolt locking assembly of claim 9 further comprising one or more drive pawls, wherein said one or more drive pawls actuate a deadbolt.

16. The deadbolt locking assembly of claim 15 comprising two drive pawls, one drive pawl to move said deadbolt to the extended position and one drive pawl to move said deadbolt to the retracted position.

17. The deadbolt locking mechanism of claim 9 further comprising a light source that illuminates a portion of said deadbolt locking assembly.

18. A deadbolt locking assembly comprising:
a key-operated lock cylinder for actuating a deadbolt;
a combination dial assembly for actuating said deadbolt, said combination dial assembly comprising a dial, a drive disk, three or more combination dials, and a set of pins interconnecting said dial, said drive disk and said three or more combination dials; wherein said set of pins interconnecting said dial, said drive disk and said three or more combination dials can be moved within said combination dial assembly to provide multiple lock combinations; and
one or more drive pawls, wherein said one or more drive pawls actuate a deadbolt;
wherein said key-operated lock cylinder and said combination dial assembly operate independently of one another.

19. The deadbolt locking assembly of claim 18 further comprising a light source that illuminates a portion of said deadbolt locking assembly.

20. The deadbolt locking assembly of claim 18, wherein said three or more combination disks are disposed within said combination dial.

21. The deadbolt locking assembly of claim 18 further comprising a lockout component that can be moved between two positions, a first position wherein said combination dial and key-operated lock cylinder are operable, and a second position wherein said combination dial and key-operated lock cylinder are inoperable.
